(19) United States
(12) Patent Application Publication
(10) Pub. No.: US 2003/0071251 A1
(43) Pub. Date: Apr. 17, 2003

(54) Belt reel assembly for fastening goods on a truck

(76) Inventor: Yu Fang Hu, Taichung (TW)

Correspondence Address: Hu Yu Fang, P.O. BOX 2103, Taichung, TW

(21) Appl. No.: 10/266,788

(22) Filed: Oct. 9, 2002

(30) Foreign Application Priority Data
Oct. 16, 2001 (TW) 90217613

(51) Int. Cl. B66F 3/00

(52) U.S. Cl. 254/218

(57) ABSTRACT

A belt reel assembly includes a main frame and a lever pivotally mounted to each other by an axle. The main frame has a first stop plate slidably mounted to selectively engage to ratchet that id mounted on the axle and the lever has a second stop plate mounted to drive the ratchet. A groove is defined in the main frame and has one side formed with a limiting side. The strain of the belt can reverse the axle to release the belt when the stop plate of the lever is moved within the groove. The ratchet drive the stop plate to abut the limiting side and then the ratchet is engaged to the stop plate of the main frame and stopping release the strain of the belt to accomplish the function of releasing the strain of the belt step by step.

### BACKGROUND OF THE INVENTION

1. Field of the Invention

The present invention relates to a belt reel assembly, and more particularly to a belt reel assembly for fastening goods on a truck. The belt reel assembly can release the strain of the belt step by step.

2. Description of Related Art

A conventional in accordance with the prior art shown in FIGS. 10 and 11, comprises an axle (81) extending through a main frame (82) and a lever (83) to pivotally mount the main frame and the lever to each other. The axle (81) includes two opposite ends each having a ratchet (84) engaged to the axle (81) and a slot (811) diametrically defined in the axle (81) to allow a belt (9) penetrating the axle (81) and being reeled on the axle (81). A first stop plate (821) partially slidably mounted in the main frame (82) and selectively engaged to the ratchets (84) due to a restitution force of a spring (822) that is compressively mounted between the first stop plate (821) and the main frame (82). A second stop plate (831) is partially slidably mounted in the lever (83) and selectively engaged to the ratchets (84) due to a restitution force of a second spring (832) that is compressively mounted between the lever (83) and the second stop plate (831). Consequently, the axle (81) is driven to reel the belt (9) by the lever, (83) when the lever (83) is backward twisted relative to the main frame (82). The main frame (82) has a groove defined to selectively receive the second stop plate (831) and the second stop plate (831) is separated relative to the ratchets (84) when the second stop plate (831) is partially received in the groove (831). Furthermore, the lever (83) has a raised portion (833) extending therefrom. The raised portion (833) backward pushes the first stop plate (821) to make the first stop plate (821) escape from the ratchets (84) when the second stop plate (831) is received in the groove (823). Then the axle (81) is in a free condition and the strain of the belt (9) is released.

The foregoing belt reel assembly is usually provided to fasten the belt (9) for fixing goods on a truck. To operate the conventional belt reel, the belt has one end fixed on the truck and the other extending through the slot (811) of the axle (81) after coiling the goods and the main frame ((82) is connected to a hook (not shown) that is detachably secured on the truck. The belt (9) is tightly reeled by the axle (81) to fasten the goods when the lever (83) is twisted back and forth to drive the axle (81). When releasing the belt (9), the lever (83) is twisted to make the second stop plate (831) partially received in the groove (823) and separated relative to the ratchets (84). At the same time, the raised portion (833) of the lever (83) backward pushes the first stop plate (821) to make the first stop plate (821) separated relative to the ratchets (84). Consequently, the axle (81) is in a free condition and the strain of the belt (9) is released for operator to remove the goods from the truck.

However, the strain of the belt (9) is released in an instant such that the goods may fall from the truck at the time the strain of the belt (9) is released. It is very dangerous because the falling goods will hurt the operator.

The present invention has arisen to mitigate and/or obviate the disadvantages of the conventional belt reel assembly for fastening goods on a truck.

### SUMMARY OF THE INVENTION

The main objective of the present invention is to provide an improved belt reel assembly for fastening goods on a truck and the belt reel assembly can release the strain of the belt step by step.

To achieve the objective, the belt reel assembly in accordance with the present invention comprises an axle extending through a main frame and a lever for pivotally mounting the main frame and the lever to each other, the main frame including two opposite sides each having an ear extending therefrom, the lever including two opposite sides each having an ear extending therefrom, the ears of the frame and the ears of the lever being parallel to and aligning with one another, the axle penetrating through the ears of the main frame and the lever, the axle including two opposite ends each having a ratchet mounted between the ears of the main frame and the lever for unidirectionally driving the axle, each ratchet having multiple teeth formed on an outer periphery thereof, the two opposite sides of the main frame each having a first slot defined therein and toward the ear of the main frame, a first stop plate laterally extending through the main frame via the first slots and partially received in the first slots, the first stop plate slidably mounted in the main frame and selectively engaging to a corresponding one of the teeth, a first spring mounted between the first stop plate and the main frame to provide a restitution force to the first stop plate, the two opposite sides of the lever each having a second slot defined therein and toward the ear of the lever, a second stop plate laterally extending through the lever via the second slots and partially received in the second slots, the second stop plate slidably mounted in the lever and selectively engages to a corresponding one of the teeth, a second spring mounted between the second stop plate and the lever to provide a restitution force to the second stop plate, the ear of the main frame having a sliding portion formed thereon, the sliding portion including first end connected to the main frame and a second end having a stopper radially extending from the ear of the main frame, a groove defined in the ear of the main frame opposite to the first slot and a raised portion extending from the ear of the lever to backward push the first stop plate, the groove having a width being approximately equal to a pitch between every two teeth, the groove including a limiting side formed adjacent to the stopper to prevent the second stop plate (21) from escaping from the groove and a stopping side formed near the indentation, the second stop plate being separated relative to the ratchet when the second stop plate is limited by the limiting side, the raised portion of the lever backward pushing the first stop plate to be separated relative to the ratchet when the second stop plate abuts the stop side and is secured in the indentation. The belt reel assembly of the present invention prevents the strain of the belt from being released in an instant such that the goods should not suddenly fall from the truck when the strain of the belt is released. Consequently, an unloading work is safe relative to the operator.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a belt reel assembly for fastening goods on a truck in accordance with the present invention;

FIG. 2 is an operational side cross-sectional view of the belt reel assembly in FIG. 1 when the belt is reeled;

FIG. 3 is an operational side cross-sectional view of the belt reel assembly in FIG. 1 when the belt is released;

FIG. 4 is an operational side cross-sectional view of the belt reel assembly in FIG. 1 when the belt is released;

FIG. 5 is an operational side cross-sectional view of the belt reel assembly in FIG. 1 when the belt is released;

FIG. 6 is an operational side cross-sectional view of the belt reel assembly in FIG. 1 when the belt is released;

FIG. 7 is a side cross-sectional view of the belt reel assembly in FIG. 1 when the axle is in a free condition;

FIG. 8 is a perspective view of another embodiment of the belt reel assembly for fastening goods on a truck in accordance with the present invention;

FIG. 9 is an operational side cross-sectional view of the belt reel assembly in FIG. 8;

FIG. 10 is a perspective view of a belt reel assembly for fastening goods on a truck in accordance with the prior art; and

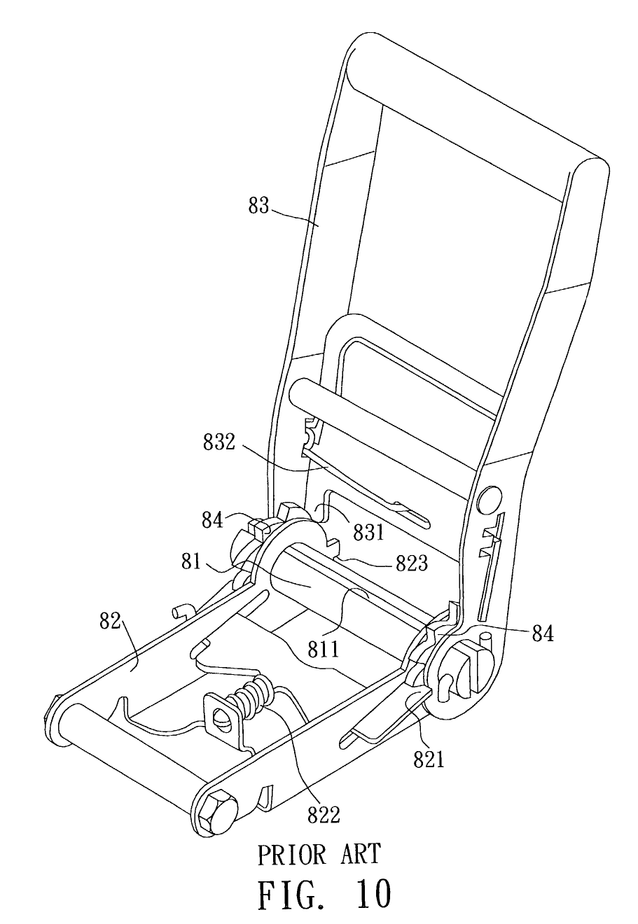

FIG. 11 is side cross-sectional view of the belt reel assembly in FIG. 10 when the axle is in a free condition.

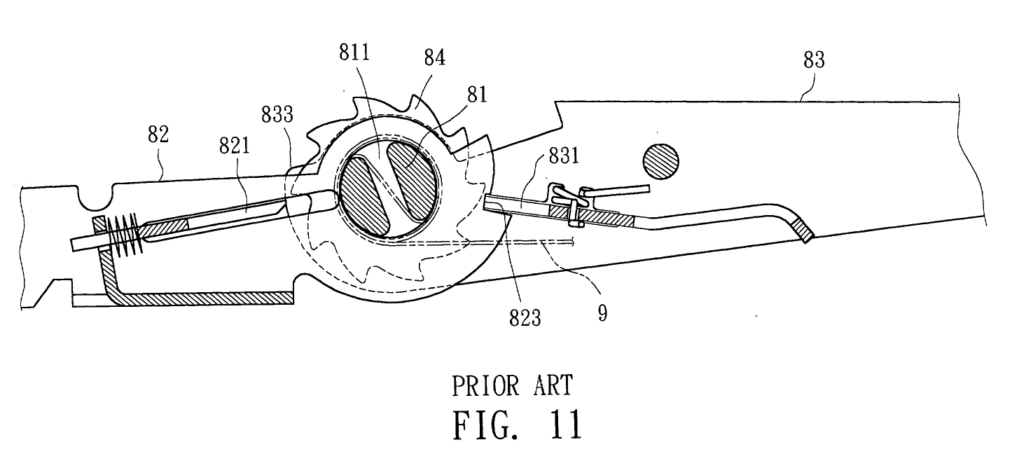

### DETAILED DESCRIPTION OF THE INVENTION

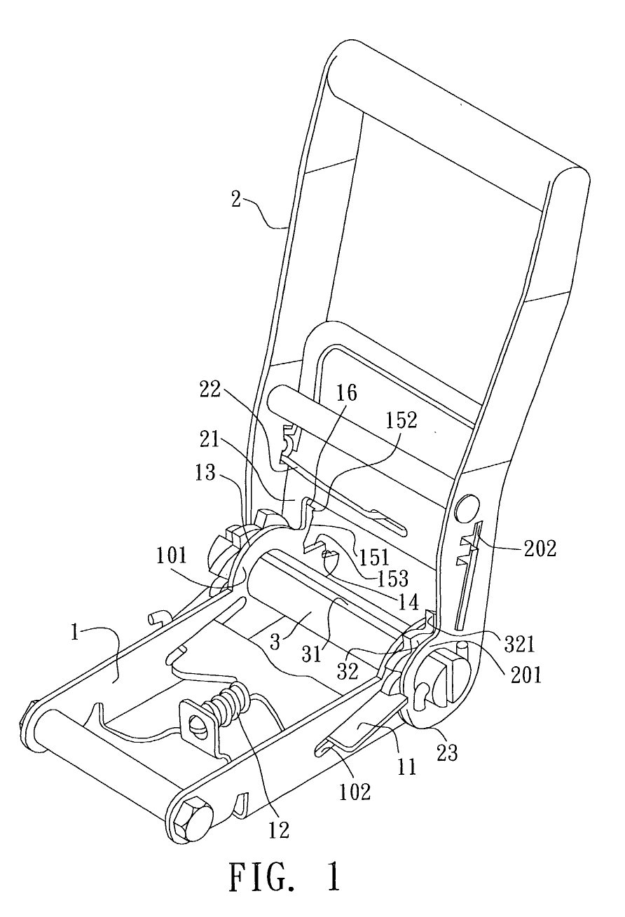

Referring to the drawings and initially to FIGS. 1-6, a belt reel assembly for fastening goods on a truck in accordance with the present invention comprises an axle (3) extending through a main frame (1) and a lever (2) for pivotally mounting the main frame (1) and the lever to each other. The main frame (1) includes two opposite sides each having an ear (101) extending therefrom. The lever (2) includes two opposite sides each having an ear (201) extending therefrom. The ear (101) of the main frame (1) and the ear (201) of the lever (2) are parallel to and align with each other. The axle (3) penetrates through the ears (101, 201) of the main frame (1) and the lever (2). The axle (3) includes two opposite ends each having a ratchet (32) mounted between the ears (101, 201) of the main frame (1) and the lever (2) for driving the axle (3). The ratchet (32) has multiple teeth (321) formed on a periphery thereof. Each tooth (321) has a sliding side (322) formed to allow the first stop plate (11) and the second stop plate (21) being moved to an adjacent tooth (321) of the ratchet (32). The axle (3) has a slot (31) diametrically defined therein and extending through the axle (3). The slot (31) is adapted to allow a belt (4) penetrating the axle (3) and wound on the axle (3).

The two opposite sides of the main frame (1) each has a first slot (102) defined therein and toward the ear (101) of the main frame (1). A first stop plate (11) laterally extends through the main frame (1) via the first slots (102) and partially received in the first slots (102). The first stop plate (11) is slidably mounted in the main frame (1) and selectively engages to a corresponding one of the teeth (321) of the ratchet (32). A first spring (12) is mounted between the first stop plate (11) and the main frame (1) to provide a restitution force to the first stop plate (11).

The two opposite sides of the lever (2) each has a second slot (202) defined therein and toward the ear (201) of the lever (2). A second stop plate (21) laterally extends through the lever (2) via the second slots (202) and partially received in the second slots (202). The second stop plate (21) is slidably mounted in the lever (2) and selectively engages to a corresponding one of the teeth (321) of the ratchet (32). A second spring (22) is mounted between the second stop plate (21) and the lever (2) to provide a restitution force to the second stop plate (21).

The ear (101) of the main frame (1) has a sliding portion (13) formed thereon. The sliding portion (13) includes first end connected to the main frame (1) and a second end having a stopper (16) radially extending from the ear (101) of the main frame (1). A groove (15) is defined in the ear (101) of the main frame (1) opposite to the first slot (102). An indentation (14) is defined in the ear (101) of the main frame (1) below the groove (15) relative to the stopper (16). A raised portion (23) extends from the ear (201) of the lever (2) to backward push the first stop plate (11).

The second stop plate (21) is engaged to the ratchets (32) when the second stop plate (21) is moved within the sliding portion (13) and then the raised portion (23) is separated relative to the first stop plate (11). The stopper (16) has a length relative to the axle (3) longer than that of an outer periphery of the ratchet (32) relative to the axle (3) such that the second stop plate (21) is separated relative to the ratchet (32) when the second stop plate (21) is moved over the stopper (16). The groove (15) has a width being approximately equal to a pitch between every two teeth (321) of the ratchet (32). The groove (15) includes a guiding side (151) formed adjacent to the stopper (16) and a stopping side (153) formed near the indentation (14). A recess (152) is defined in the guiding side (151) near a top of the stopper (16) to prevent the second stop plate (21) from escaping from the groove (15) along the guiding side (151). The guiding side (151) corresponds to a corresponding one of the sliding sides (322) of the ratchets (32) and the distance between the recess (152) and the axle (3) is longer than that between the top of the tooth (321) and the axle (3) such that the second stop plate (21) is separated relative to the ratchet (32) when the second stop plate (21) is engaged to the recess (152). The raised portion (23) of the lever (2) backward pushes the first stop plate (11) to be separated relative to the ratchet (32) when the second stop plate (21) abuts the stop side (153) or is secured in the indentation (14).

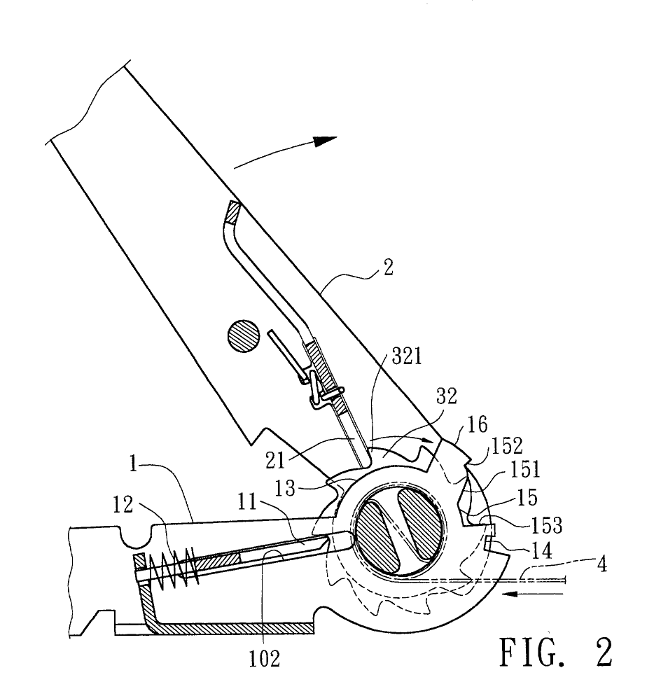

With reference to FIG. 2, the second stop plate (21) is engaged to the ratchet (23) when moved within the sliding portion (13) of the main frame (1) and the ratchet (23) is unidirectionally engaged to the first stop plate (11). Consequently, the axle (3) is driven and rotates to reel and tightly pull the belt (4) for fastening goods.

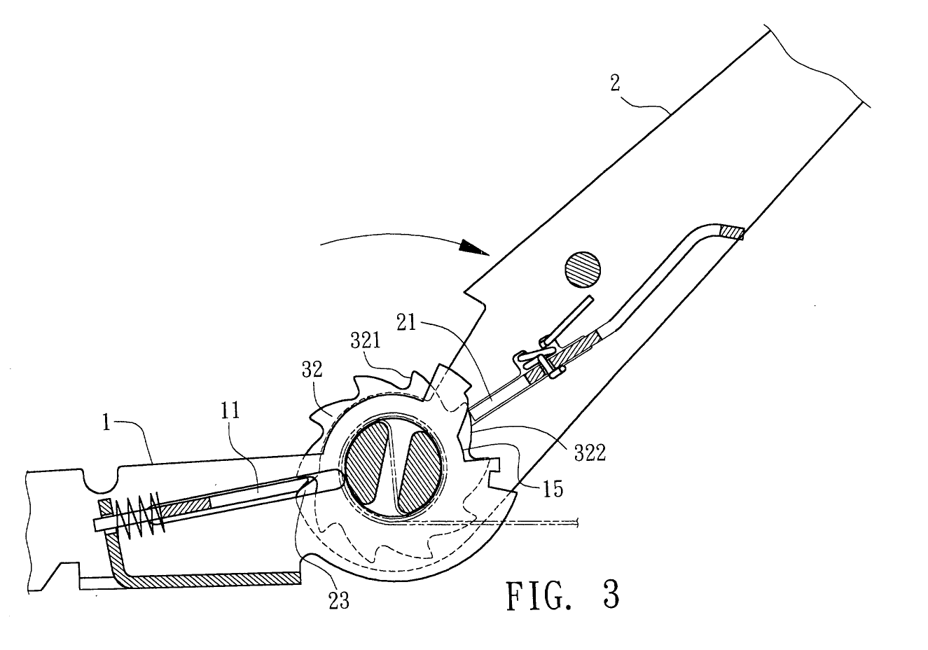

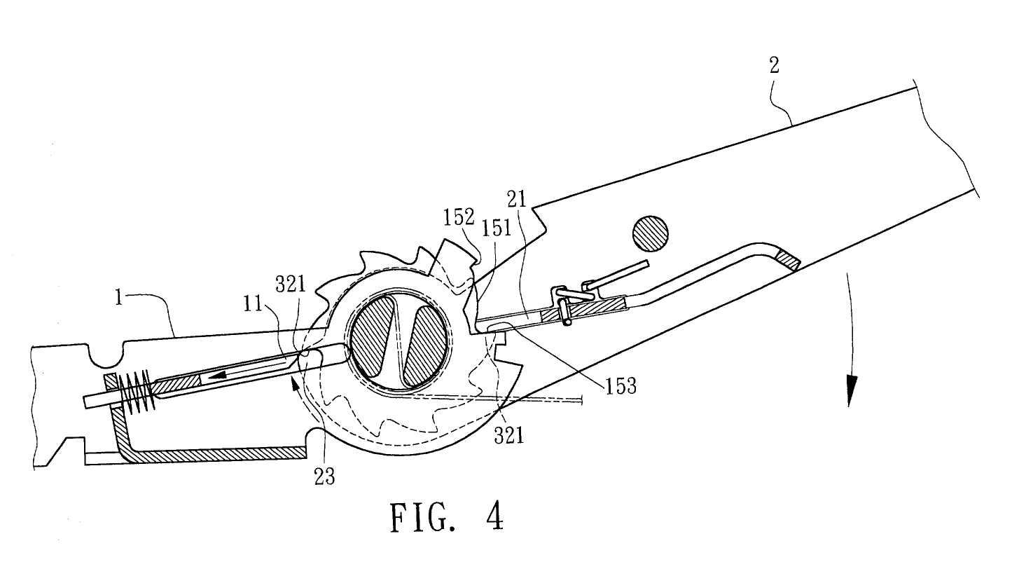

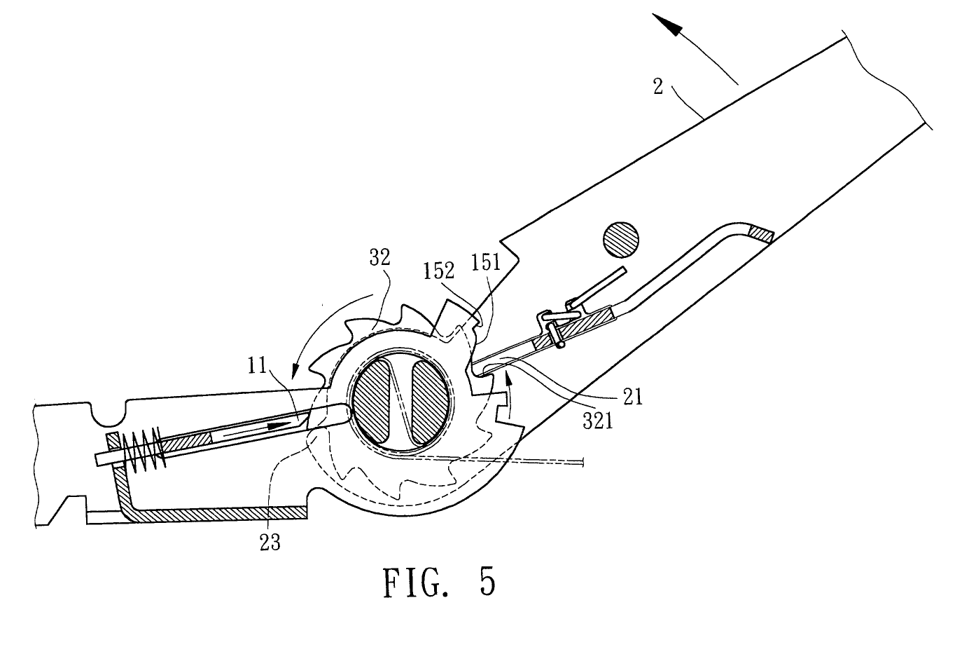

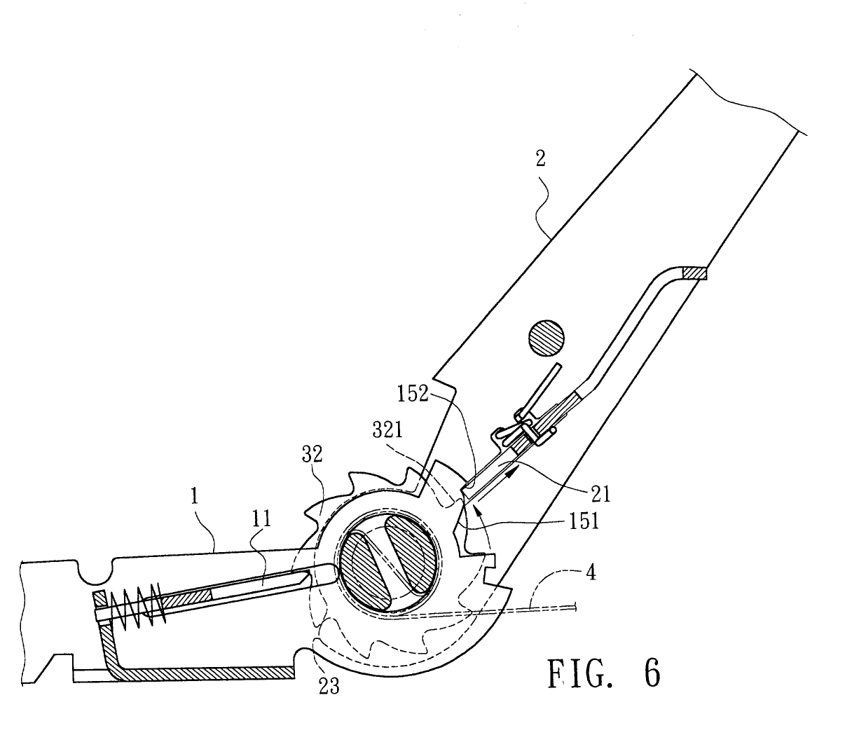

When releasing the belt (4), with reference to FIGS. 3 and 4, the second stop plate (21) is backward pulled relative to the ratchet (32) and the lever (2) is twisted to make the second stop plate (21) being moved over the stopper (16) and positioned within the groove (15) to abut the sliding side (322) of the tooth (321) of the ratchet (32), in the meanwhile, the first stop plate (11) is engaged to the ratchet (32). The first stop plate (11) is backward pushed and separated to the ratchet (32) such that the axle (3) and the ratchet (32) are in a free condition. Consequently, the axle (3) and the ratchets (32) are reversed due the strain of the belt (4). With reference to FIGS. 5 and 6, the reversing axle (3) and the ratchets (32) will drive the lever (2) moved toward the recess (152) and the raised portion (23) is moved away from the first stop plate (11) such that the first stop plate (11) is engaged to an adjacent tooth (321) to prevent the strain of the belt (4) from being releasing in an instant. At the same time, the tooth (321) pushes the second stop plate (21) moved along the guiding portion (151) till the second stop plate (21) engaged to the recess (152) and the tooth (321) that pushes the second stop plate (21) passes over the second stop plate (21). Repeating the steps in FIGS. 3-6, the releasing range of the belt (4) is equal to the pitch of the teeth (321) of the ratchet (32) such that the present invention has arisen to mitigate and/or obviate the disadvantages of the conventional belt reel assembly that releases the strain of the belt (4) in an instant.

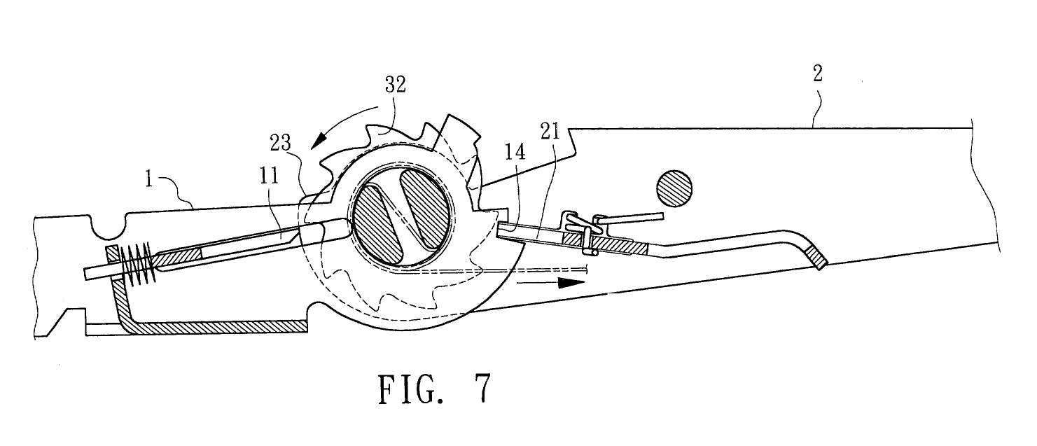

With reference to FIGS. 6 and 7, the operator can backward pull the second stop plate (21) and twist the lever (2) to make the second stop plate (21) being fixed in the indentation (14) when the strain of the belt (4) is released. Then the ratchet (32) and the axle (3) are in a free condition so that the operator can pull the belt (4) from the belt reel assembly for conveniently unloading goods from a truck.

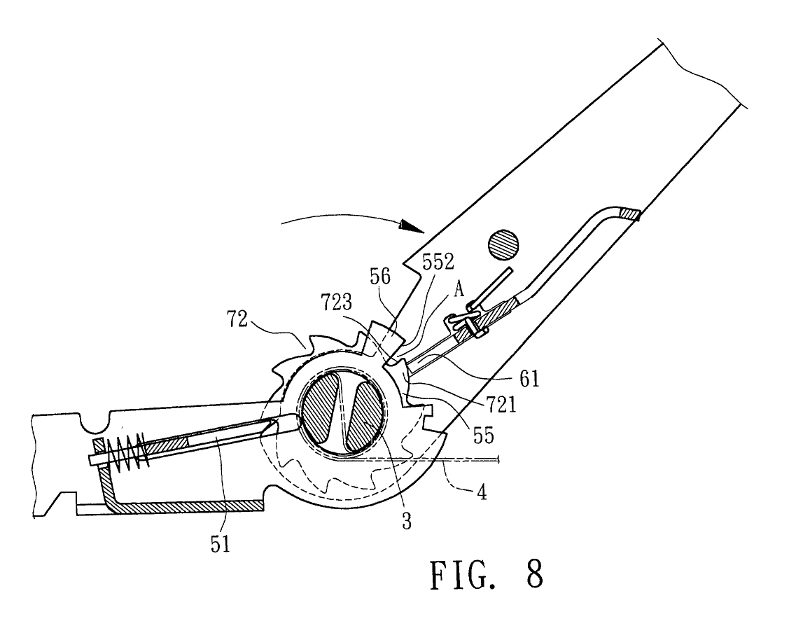

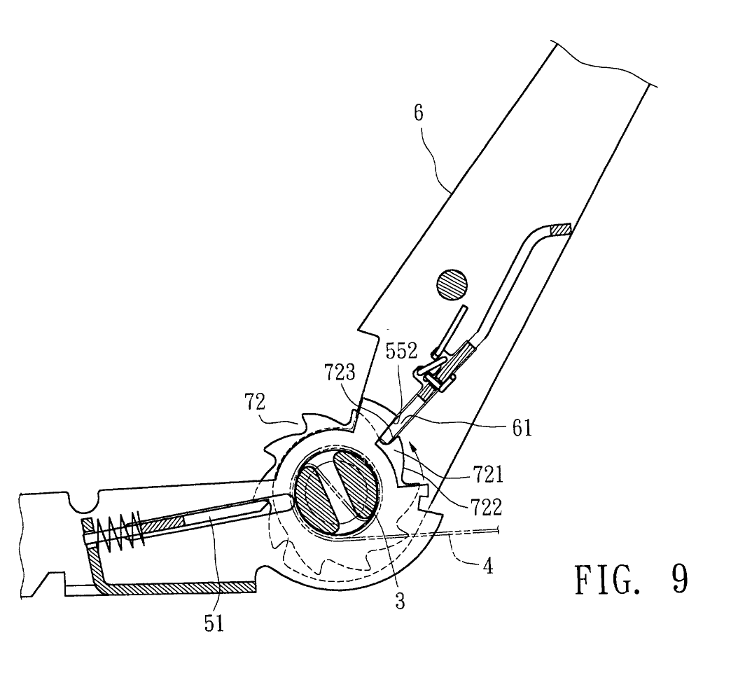

With reference to FIGS. 8 and 9, it is another embodiment of the present invention, wherein the groove (55) has a limiting side (552) formed adjacent the stopper (56) and the tooth (721) has a stop portion (723) along a diameter of the ratchet (72) and a guiding portion (722) obliquely connected to the stop portion (723) of an adjacent tooth (721) of the ratchet (72). A gap (A) is defined between the second stop plate (61) and the limiting side (552) of the groove (55) when the first stop plate (51) is engaged to the ratchet (72). The gap (A) is provided to partially receive the second stop plate (61) such that second stop plate (61) can drive the ratchet (72) and rotates the axle (3) to tightly reel the belt (4). Repeating the releasing steps of the above-mentioned embodiment of the present invention, the first stop plate (51) is engaged to the ratchet (72) and the second stop plate (61) is clamped between the limiting side (552) and the stop portion (723) of the tooth (721) when the ratchet (72) reverses to a pitch of each two teeth (721) of the ratchet (72). The second stop plate (61) is backward pulled over the tooth (721) for next releasing step.

As described above, the belt reel assembly in accordance with the present invention has arisen to mitigate and/or obviate the disadvantages of the conventional belt reel assembly and prevents the strain of the belt from being released in an instant such that the goods should not suddenly fall from the truck when the strain of the belt is released. Consequently, an unloading work is safe relative to the operator.

Although the invention has been explained in relation to its preferred embodiment, it is to be understood that many other possible modifications and variations can be made without departing from the spirit and scope of the invention as hereinafter claimed.

What is claimed is:

1. A belt reel assembly for fastening goods on a truck, comprising an axle extending through a main frame and a lever for pivotally mounting the main frame and the lever to each other, the main frame including two opposite sides each having an ear extending therefrom, the lever including two opposite sides each having an ear extending therefrom, the ears of the frame and the ears of the lever being parallel to and aligning with one another, the axle penetrating through the ears of the main frame and the lever, the axle including two opposite ends each having a ratchet mounted between the ears of the main frame and the lever for unidirectionally driving the axle, each ratchet having multiple teeth formed on an outer periphery thereof, the two opposite sides of the main frame each having a first slot defined therein and toward the ear of the main frame, a first stop plate laterally extending through the main frame via the first slots and partially received in the first slots, the first stop plate slidably mounted in the main frame and selectively engaging to a corresponding one of the teeth, a first spring mounted between the first stop plate and the main frame to provide a restitution force to the first stop plate, the two opposite sides of the lever each having a second slot defined therein and toward the ear of the lever, a second stop plate laterally extending through the lever via the second slots and partially received in the second slots, the second stop plate slidably mounted in the lever and selectively engages to a corresponding one of the teeth, a second spring mounted between the second stop plate and the lever to provide a restitution force to the second stop plate, the ear of the main frame having a sliding portion formed thereon, the sliding portion including first end connected to the main frame and a second end having a stopper radially extending from the ear of the main frame, a groove defined in the ear of the main frame opposite to the first slot and a raised portion extending from the ear of the lever to backward push the first stop plate, the groove having a width being approximately equal to a pitch between every two teeth, the groove including a limiting side formed adjacent to the stopper to prevent the second stop plate (21) from escaping from the groove and a stopping side formed near the indentation, the second stop plate being separated relative to the ratchet when the second stop plate is limited by the limiting side, the raised portion of the lever backward pushing the first stop plate to be separated relative to the ratchet when the second stop plate abuts the stop side and is secured in the indentation.

2. The belt reel assembly as claimed in claim 1, wherein the groove comprises a guiding side formed adjacent to the stopper and a recess is defined in the guiding side near a top of the stopper to prevent the second stop plate from escaping from the groove along the guiding side, a distance between the recess and the axle being longer than that between the top of the tooth and the axle such that the second stop plate is separated relative to the ratchet when the second stop plate is engaged to the recess.
